(19) United States
(12) Patent Application Publication
(10) Pub. No.: US 2021/0174675 A1
(43) Pub. Date: Jun. 10, 2021

(54) Traffic Light Display Assembly

(71) Applicant: Charles Bolton, Norwood, MA (US)

(72) Inventor: Charles Bolton, Norwood, MA (US)

(21) Appl. No.: 16/705,418

(22) Filed: Dec. 6, 2019

(51) Int. Cl. G08G 1/095; G06F 3/041; B60Q 1/30

(52) U.S. Cl. CPC G08G 1/095; G06F 3/0412; B60R 2300/406; B60R 2300/202; B60Q 1/30

(57) ABSTRACT

A traffic light display assembly includes a control panel that is positioned on a dashboard of a semi tractor. The control panel includes a camera for viewing a traffic light which the semi tractor is facing. A display unit is removably coupled to a back side of a semi trailer to be visible to traffic behind the semi trailer. The display unit is in remote communication with the control panel. Moreover, the display unit has a plurality of light emitters thereon each being associated with a respective light on the traffic light at which the semi tractor facing. Each of the light emitters is turned on when the associated light on the traffic light is turned on to communicate the status of the traffic light to the traffic behind the semi trailer.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to traffic display devices and more particularly pertains to a new traffic display device for communicating traffic light status to traffic behind a semi trailer.

### (2) Description of Related Art Including Information Disclosed Under 37 CFR 1.97 and 1.98

The prior art relates to traffic display devices. The prior art discloses a variety of assemblies which incorporate a front facing camera and a rear facing display. The rear facing display displays imagery captured by the front facing camera for the benefit of traffic that is following behind a vehicle on which the front facing camera and rear facing display are mounted. The prior art discloses a traffic light that is mountable to the rear of a vehicle and a forward facing camera. The traffic light is in communication with the forward facing camera and lights on the traffic light are illuminated in accordance with a traffic signal to facilitate traffic behind the vehicle to see the status of the traffic signal. In each instance of the prior art disclosed, the camera is mounted to the exterior of the vehicle.

### BRIEF SUMMARY OF THE INVENTION

An embodiment of the disclosure meets the needs presented above by generally comprising a control panel that is positioned on a dashboard of a semi tractor. The control panel includes a camera for viewing a traffic light which the semi tractor is facing. A display unit is removably coupled to a back side of a semi trailer to be visible to traffic behind the semi trailer. The display unit is in remote communication with the control panel. Moreover, the display unit has a plurality of light emitters thereon each being associated with a respective light on the traffic light at which the semi tractor facing. Each of the light emitters is turned on when the associated light on the traffic light is turned on to communicate the status of the traffic light to the traffic behind the semi trailer.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a traffic light display assembly according to an embodiment of the disclosure.

FIG. 2 is a phantom perspective view of an embodiment of the disclosure.

FIG. 3 is a left side view of an embodiment of the disclosure.

FIG. 4 is a back in-use view of an embodiment of the disclosure.

FIG. 5 is a perspective in view of an embodiment of the disclosure.

### DETAILED DESCRIPTION OF THE INVENTION

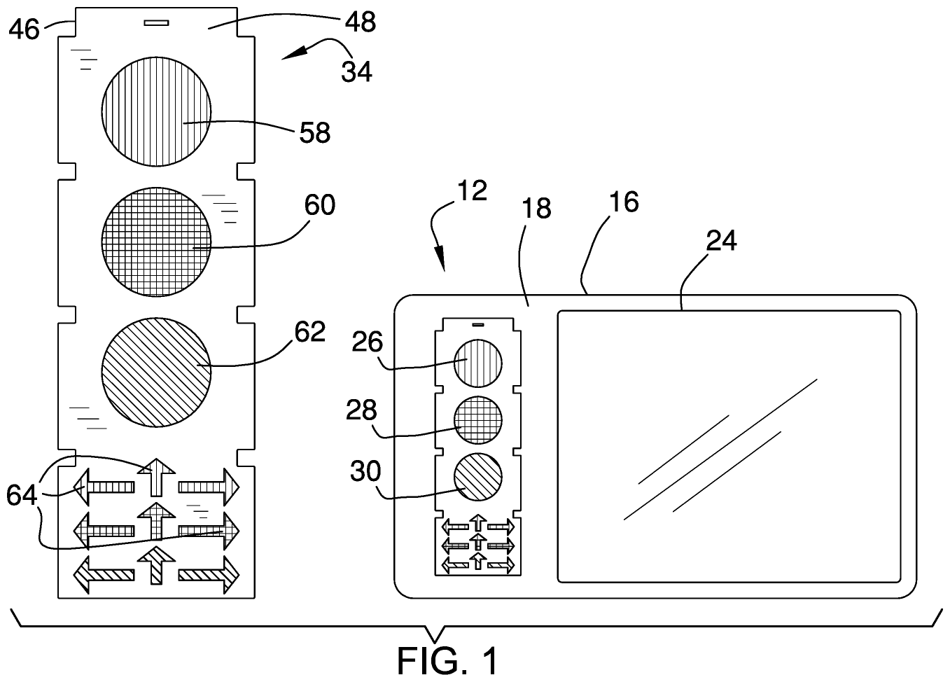

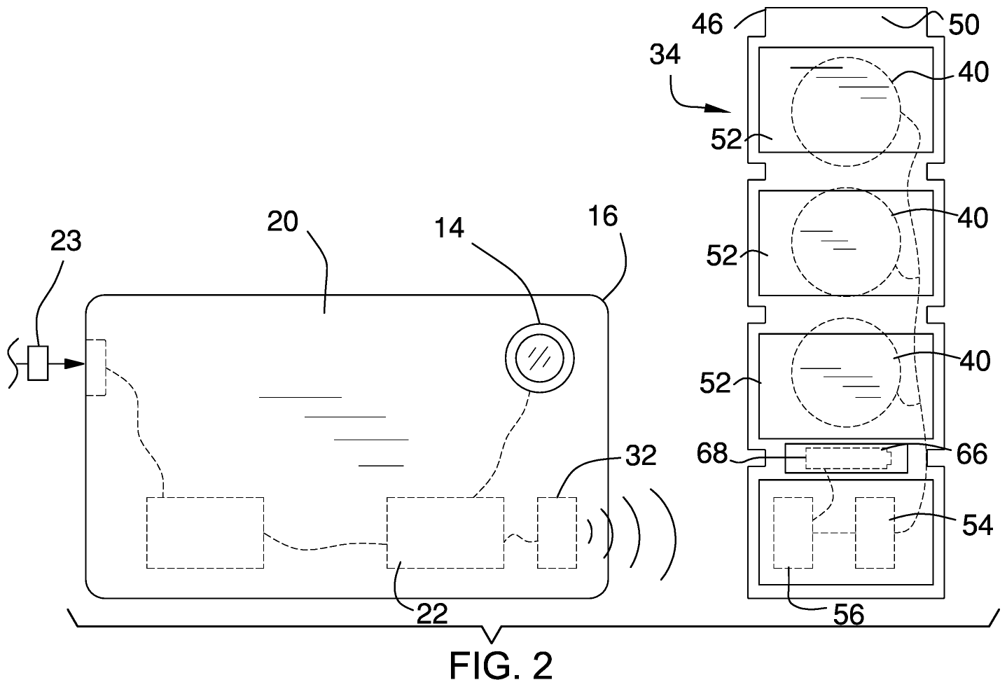

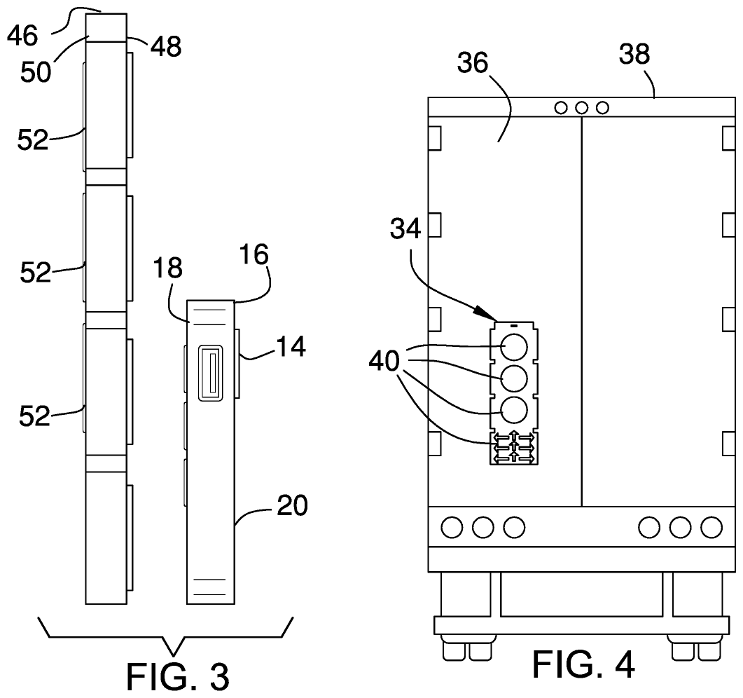

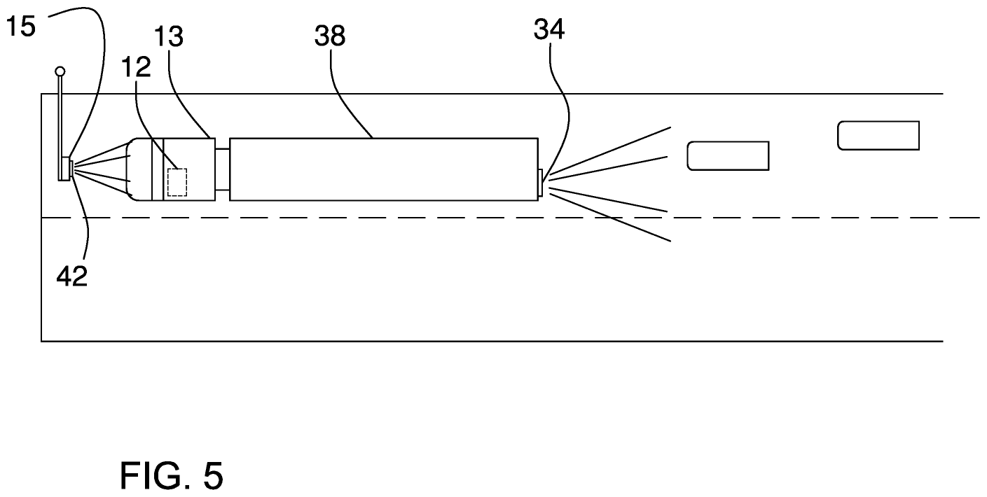

With reference now to the drawings, and in particular to FIGS. 1 through 5 thereof, a new traffic display device embodying the principles and concepts of an embodiment of the disclosure and generally designated by the reference numeral 10 will be described.

As best illustrated in FIGS. 1 through 5, the traffic light display assembly 10 generally comprises a control panel 12 that is positioned on a dashboard of a semi tractor 13 or other vehicle of similar size that could inhibit a vehicle therebehind from viewing a traffic light. The control panel 12 is positioned such that the control panel 12 is accessible to a driver. Moreover, the control panel 12 includes a camera 14 for viewing a traffic light which the semi tractor 13 is facing. The control panel 12 comprises a control housing 16 that has a front wall 18 and a back wall 20, and the control housing 16 is positioned on the dashboard.

A control circuit 22 is positioned in the control housing 16 and the control circuit 22 is electrically coupled to a power source 23 comprising the electrical system of the semi tractor 13. The camera 14 is coupled to the back wall 20 of the control housing 16 to capture imagery of the traffic light. The camera 14 may be a digital video camera or other similar device that can capture imagery of the traffic light. Additionally, the control circuit 22 includes image detection software for analyzing imagery captured by the camera 14 thereby facilitating traffic lights, and the status of lights on the traffic lights, to be identified.

The control circuit 22 receives a go input when the camera 14 detects that a green light on the traffic light 15 is illuminated. The control circuit 22 receives a caution input when the camera 14 detects that a yellow light on the traffic light 15 is illuminated. The control circuit 22 receives a stop input when the camera 14 detects that a red light on the traffic light 15 is illuminated. Additionally, the control circuit 22 receives an arrow input when the camera 14 detects that a direction arrow on the traffic light 15 is illuminated.

The control panel 12 includes a touch screen 24 that is coupled to the front wall 18 of the control housing 16 and the touch screen 24 is electrically coupled to the control circuit 22. The touch screen 24 displays indicia comprising text and images for controlling operational parameters of the control circuit 22. Additionally, the touch screen 24 may comprise an LED, or other similar electronic display, that responds to touch.

A stop light emitter 26 is coupled to the front wall 18 of the control housing 16 and the stop light emitter 26 is electrically coupled to the control circuit 22. The stop light emitter 26 is turned on when the control circuit 22 receives the stop input. A slow light emitter 28 is coupled to the front wall 18 of the control housing 16 and the slow light emitter 28 is electrically coupled to the control circuit 22. The slow light emitter 28 is turned on when the control circuit 22 receives the caution input. A go light emitter 30 is coupled to the front wall 18 of the control housing 16 and the go light emitter 30 is electrically coupled to the control circuit 22. The go light emitter 30 is turned on when the control circuit 22 receives the go input.

The control panel 12 includes a transmitter 32 that is coupled to the control housing 16 and the transmitter 32 is electrically coupled to the control circuit 22. Additionally, the transmitter 32 may comprise a radio frequency transmitter or the like and the transmitter 32 may employ Bluetooth communication protocols.

A display unit 34 is removably coupled to a back side 36 of a semi trailer 38 which being is towed by the semi tractor 13. In this way the display unit 34 is visible to traffic behind the semi trailer 38. Additionally, the display unit 34 is in remote communication with the control panel 12. The display unit 34 has a plurality of light emitters 40 thereon each being associated with a respective light 42 on the traffic light 15 which the semi tractor 13 is facing. Each of the light emitters 40 is associated with a respective one of the lights on the traffic light 15. Moreover, each of the light emitters 40 is turned on when the control panel 12 detects that the associated light on the traffic light 15 is turned on. In this way the display unit 34 communicates the status of the traffic light 15 to the traffic behind the semi trailer 38.

The display unit 34 comprises a remote housing 46 that has a forward side 48 and a rear side 50. The remote housing 46 may structured to have the ornamental appearance of a traffic light 15. A plurality of mating members 52 is each coupled to the rear side 50 of the remote housing 46 and each of the mating members 52 releasably engages the back side 36 of the semi trailer 38. Each of the mating members 52 may comprise a magnet that magnetically engages the back side 36 of the semi trailer 38.

The display unit 34 includes a remote control circuit 54 that is positioned in the remote housing 46. A receiver 56 is positioned in the remote control housing 16, the receiver 56 is electrically coupled to the remote control circuit 54 and the receiver 56 is in wireless communication with the transmitter 32. The receiver 56 may comprise a radio frequency receiver 56 or the like and the receiver 56 may employ Bluetooth communication protocols.

The receiver 56 receives actuation commands from the transmitter 32 for each of the light emitters 40 on the traffic light 15. Each of the actuation commands is associated with a respective one of the go input, the caution input, the stop input and the arrow input. The plurality of light emitters 40 includes a red light emitter 58, a yellow light emitter 60, a green light emitter 62 and a set of arrow light emitters 64. Moreover, each of the light emitters 40 may comprise an LED or other electronic light emitter that can emit light in a variety colors.

The red light emitter 58 is turned on when the receiver 56 receives the actuation command associated with the stop input and the yellow light emitter 60 is turned on when the receiver 56 receives the actuation command associated with the caution input. The green light emitter 62 is turned on when the receiver 56 receives the actuation command associated with the go input and respective ones of the arrow light emitters 64 are turned on when the receiver 56 receives the arrow input. The set of arrow light emitters 64 may each being shaped like an arrow pointing left, right and up. Additionally, each of the arrow light emitters 64 may emit red, green or yellow light, depending on the status of the arrows on the traffic light 15. In this way left turn, right turn and forward arrows on the traffic light 15 are communicated to the traffic behind the semi trailer 38. A power supply 66 is positioned in the remote housing 46, the power supply 66 is electrically coupled to the remote control circuit 54 and the power supply 66 comprises at least one battery 68.

In use, the control panel 12 is positioned on the dashboard thereby facilitating the camera 14 to capture imagery of the traffic lights 44. The display unit 34 is positioned on the back side 36 of the semi trailer 38 such that the display unit 34 is visible to traffic behind the semi trailer 38. Each of the light emitters 40 on the display unit 34 is turned on to reflect the status of the traffic light 15 that is being recorded by the camera 14. In this way the traffic behind the semi trailer 38 can see the status of the traffic light 15 that would otherwise not be visible to the traffic.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A traffic light display assembly being configured to be mounted to the rear of a semi trailer for alerting traffic behind the semi trailer to the status of a traffic light in front of the semi trailer, said assembly comprising:
a control panel being positioned on a dashboard of a semi tractor wherein said control panel is configured to be accessible to a driver, said control panel including a camera for viewing a traffic light which the semi tractor is facing, said control panel comprising
a control housing having a front wall and a back wall, said control housing being positioned on the dashboard,
a control circuit being positioned in said control housing, said control circuit being electrically coupled to a power source comprising the electrical system of the semi tractor, said control circuit including image detection software for analyzing imagery captured by said camera,
said camera being coupled to said back wall of said control housing wherein said camera is configured to capture imagery of the traffic light, said control circuit receiving a go input when said camera detects that a green light on the traffic light is illuminated, said control circuit receiving a caution input when said camera detects that a yellow light on the traffic light is illuminated, said control circuit receiving a stop input when said camera detects that a red light on the traffic light is illuminated, said control circuit receiving an arrow input when said camera detects that a direction arrow on the traffic light is illuminated,
a touch screen being coupled to said front wall of said control housing, said touch screen being electrically coupled to said control circuit, said touch screen displaying indicia comprising text and images for controlling operational parameters of said control circuit, and
a stop light emitter being coupled to said front wall of said control housing, said stop light emitter being electrically coupled to said control circuit, said stop light emitter being turned on when said control circuit receives said stop input; and
a display unit being removably coupled to a back side of a semi trailer being towed by the semi tractor wherein said display unit is configured to be visible to traffic behind the semi trailer, said display unit being in remote communication with said control panel, said display unit having a plurality of light emitters thereon each being associated with a respective light on the traffic light at which the semi tractor facing, each of said light emitters being turned on when said control panel detects that the associated light on the traffic light is turned on wherein said display unit is configured to communicate the status of the traffic light to the traffic behind the semi trailer.

2. (canceled)

3. (canceled)

4. (canceled)

5. (canceled)

6. The assembly according to claim 1, wherein said control panel includes a slow light emitter being coupled to said front wall of said control housing, said slow light emitter being electrically coupled to said control circuit, said slow light emitter being turned on when said control circuit receives said caution input.

7. The assembly according to claim 6, wherein said control panel includes a go light emitter being coupled to said front wall of said control housing, said go light emitter being electrically coupled to said control circuit, said go light emitter being turned on when said control circuit receives said go input.

8. The assembly according to claim 2, wherein said control panel includes a transmitter being coupled to said control housing, said transmitter being electrically coupled to said control circuit.

9. The assembly according to claim 8, wherein said display unit comprises:
a remote housing having a forward side and a rear side;
a plurality of mating members, each of said mating members being coupled to said rear side of said remote housing, each of said mating members releasably engaging the back side of the semi trailer; and
a remote control circuit being positioned in said remote housing.

10. The assembly according to claim 9, wherein said display unit includes a receiver being positioned in said remote control housing, said receiver being electrically coupled to said remote control circuit, said receiver being in wireless communication with said transmitter, said receiver receiving actuation commands from said transmitter for each of said light emitters on said traffic light, each of said actuation commands being associated with a respective one of said go input, said caution input, said stop input and said arrow input.

11. The assembly according to claim 10, wherein said plurality of light emitters includes a red light emitter, a yellow light emitter, a green light emitter and a set of arrow light emitters, said red light emitter being turned on when said receiver receives said actuation command associated with said stop input, said yellow light emitter being turned on when said receiver receives said actuation command associated with said caution input, said green light emitter being turned on when said receiver receives said actuation command associated with said go input, respective ones of said arrow light emitters being turned on when said receiver receives said arrow input.

12. The assembly according to claim 11, wherein said display unit includes a power supply being positioned in said remote housing, said power supply being electrically coupled to said remote control circuit, said power supply comprising at least one battery.

13. A traffic light display assembly being configured to be mounted to the rear of a semi trailer for alerting traffic behind the semi trailer to the status of a traffic light in front of the semi trailer, said assembly comprising:
a control panel being positioned on a dashboard of a semi tractor wherein said control panel is configured to be accessible to a driver, said control panel including a camera for viewing a traffic light which the semi tractor is facing, said control panel comprising:
a control housing having a front wall and a back wall, said control housing being positioned on the dashboard;
a control circuit being positioned in said control housing, said control circuit being electrically coupled to a power source comprising the electrical system of the semi tractor;
said camera being coupled to said back wall of said control housing wherein said camera is configured to capture imagery of the traffic light, said control circuit receiving a go input when said camera detects that a green light on the traffic light is illuminated, said control circuit receiving a caution input when said camera detects that a yellow light on the traffic light is illuminated, said control circuit receiving a stop input when said camera detects that a red light on the traffic light is illuminated, said control circuit receiving an arrow input when said camera detects that a direction arrow on the traffic light is illuminated;
a touch screen being coupled to said front wall of said control housing, said touch screen being electrically coupled to said control circuit, said touch screen displaying indicia comprising text and images for controlling operational parameters of said control circuit;
a stop light emitter being coupled to said front wall of said control housing, said stop light emitter being electrically coupled to said control circuit, said stop light emitter being turned on when said control circuit receives said stop input;
a slow light emitter being coupled to said front wall of said control housing, said slow light emitter being electrically coupled to said control circuit, said slow light emitter being turned on when said control circuit receives said caution input;
a go light emitter being coupled to said front wall of said control housing, said go light emitter being electrically coupled to said control circuit, said go light emitter being turned on when said control circuit receives said go input; and
a transmitter being coupled to said control housing, said transmitter being electrically coupled to said control circuit; and
a display unit being removably coupled to a back side of a semi trailer being towed by the semi tractor wherein said display unit is configured to be visible to traffic behind the semi trailer, said display unit being in remote communication with said control panel, said display unit having a plurality of light emitters thereon each being associated with a respective light on the traffic light at which the semi tractor facing, each of said light emitters being turned on when said control panel detects that the associated light on the traffic light is turned on wherein said display unit is configured to communicate the status of the traffic light to the traffic behind the semi trailer, said display unit comprising:
a remote housing having a forward side and a rear side;
a plurality of mating members, each of said mating members being coupled to said rear side of said remote housing, each of said mating members releasably engaging the back side of the semi trailer;
a remote control circuit being positioned in said remote housing;
a receiver being positioned in said remote control housing, said receiver being electrically coupled to said remote control circuit, said receiver being in wireless communication with said transmitter, said receiver receiving actuation commands from said transmitter for each of said light emitters on said traffic light, each of said actuation commands being associated with a respective one of said go input, said caution input, said stop input and said arrow input, said plurality of light emitters including a red light emitter, a yellow light emitter, a green light emitter and a set of arrow light emitters, said red light emitter being turned on when said receiver receives said actuation command associated with said stop input, said yellow light emitter being turned on when said receiver receives said actuation command associated with said caution input, said green light emitter being turned on when said receiver receives said actuation command associated with said go input, respective ones of said arrow light emitters being turned on when said receiver receives said arrow input; and
a power supply being positioned in said remote housing, said power supply being electrically coupled to said remote control circuit, said power supply comprising at least one battery.
